(19) United States
(12) Patent Application Publication
(10) Pub. No.: US 2023/0401440 A1
(43) Pub. Date: Dec. 14, 2023

(54) WEIGHT SHARING BETWEEN DEEP LEARNING MODELS USED IN AUTONOMOUS VEHICLES

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/840,185

(22) Filed: Jun. 14, 2022

(51) Int. Cl. G06N 3/08; G06K 9/62; G06K 9/00; G06N 3/04; B60W 40/02; B60W 60/00

(52) U.S. Cl. CPC G06N 3/08; G06K 9/6267; G06K 9/00523; G06N 3/04; B60W 40/02; B60W 60/00

(57) ABSTRACT

Some autonomous vehicles rely on deep learning models to generate outputs that can be used to control the autonomous vehicle. Deep learning models can be trained to fit datasets collected in a particular environment. These deep learning models may not perform as well in a different environment, and new deep learning models may need to be created and trained. Training new models can be computationally expensive, and the amount of datasets collected in a new environment for training the new models may be limited. Various techniques involving sharing parameters (e.g., weights) between deep learning models can alleviate some of these challenges.

### TECHNICAL FIELD

The present disclosure relates generally to autonomous vehicles, and more particularly, to weight sharing between deep learning models used in autonomous vehicles.

### BACKGROUND

Autonomous vehicles, also known as self-driving cars, driverless vehicles, and robotic vehicles, may be vehicles that use multiple sensors to sense the environment and move without human input. Technology in the autonomous vehicles may enable the vehicles to drive on roadways and to accurately and quickly perceive the vehicle's environment, including obstacles, signs, and traffic lights.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates an exemplary autonomous vehicle with sensor data adaptation, according to some embodiments of the disclosure;

FIG. 2 illustrates autonomous vehicles with different sets of vehicle hardware, according to some embodiments of the disclosure;

FIGS. 3A-3B illustrate ways how vehicle surroundings can differ, according to some embodiments of the disclosure;

FIG. 4 illustrates an exemplary artificial neural network having agnostic nodes and dependent nodes, according to some embodiments of the disclosure;

FIG. 5 illustrates an exemplary convolutional neural network having agnostic nodes and dependent nodes, according to some embodiments of the disclosure;

FIG. 6 is a flow diagram illustrating a method for training a deep learning model, according to some embodiments of the disclosure;

FIG. 7 is a flow diagram illustrating another method for training a deep learning model, according to some embodiments of the disclosure;

FIG. 8 is a flow diagram illustrating another method for training a deep learning model, according to some embodiments of the disclosure;

FIG. 9 is a flow diagram illustrating a method for applying a deep learning model, according to some embodiments of the disclosure; and

FIG. 10 illustrates an exemplary computing system used in various embodiments of the disclosure.

### DETAILED DESCRIPTION

Overview

Some autonomous vehicles rely on deep learning models to generate outputs that can be used to control the autonomous vehicle. Deep learning models can be trained to fit datasets collected in a particular environment. These deep learning models may not perform as well in a different environment, and new deep learning models may need to be created and trained. Training new models can be computationally expensive, and the amount of datasets collected in a new environment for training the new models may be limited. Various techniques involving sharing parameters (e.g., weights) between deep learning models can alleviate some of these challenges.

For some autonomous vehicle systems, the deep learning models are designed, trained, and optimized for a specific environment, because the deep learning models are trained based on datasets having signals collected in the specific environment only. Different environments may yield different datasets. One way the environments differ is that the signals are collected using a different set of vehicle hardware. Another way the environments differ is that the signals are collected in different vehicle surroundings. Designing, training, and optimizing new deep learning models can consume a lot of resources.

To address this problem, a given deep learning model is divided into environment-agnostic nodes and environment-dependent nodes (referred herein simply as agnostic nodes and dependent nodes respectively). An environment-specific deep learning model can be constructed by combining agnostic nodes and dependent nodes that correspond to a specific environment. A collection having many different environment-specific deep learning models can be constructed in this manner, accommodating many different environments. Through the agnostic nodes, learnings from different environments can be shared or leveraged across the different environment-specific deep learning models.

During training of a given environment-specific deep learning model having agnostic nodes and dependent nodes, the agnostic nodes are frozen and only the dependent nodes are trained using a dataset that corresponds to a specific environment. Amount of resources needed to train for a new environment can be reduced. Occasionally, the agnostic nodes are trained using datasets from all the different environments. Learnings can then be shared between different environment-specific deep learning models.

When operating an autonomous vehicle in specific environment in the real world or in simulation, a deep learning model constructed from agnostic nodes and dependent nodes corresponding to the specific environment is applied. The need and resources to design, train, and optimize a whole new deep learning model in order for the autonomous vehicle to operate in a new environment are avoided or alleviated. The environment can be determined or sensed, and an environment-specific deep learning model corresponding to the determined environment can be constructed accordingly. Different environment-specific deep learning models can be deployed and applied in response to different environments in a streamlined and flexible fashion.

Exemplary Autonomous Vehicle

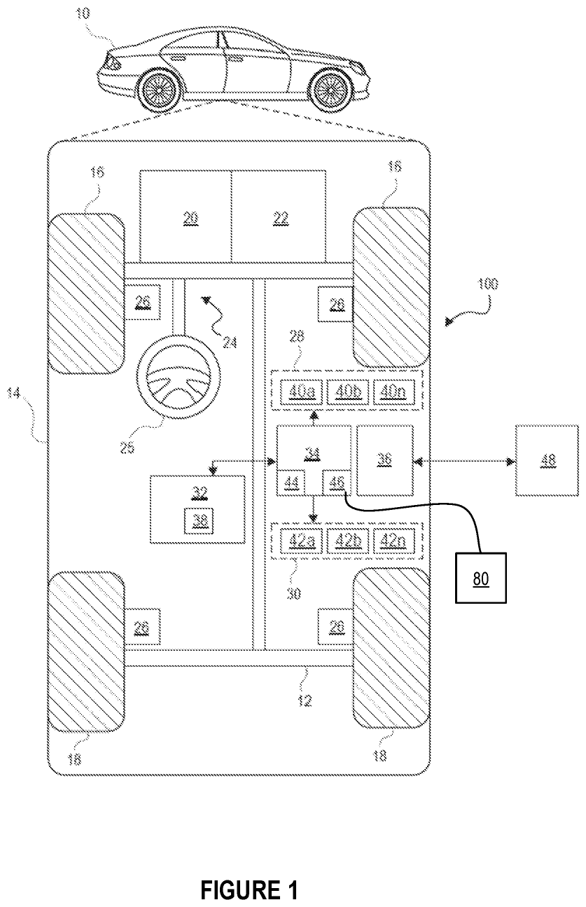

FIG. 1 illustrates an exemplary autonomous vehicle 10 with sensor data adaptation, according to some embodiments of the present disclosure. Autonomous vehicles can provide many benefits. For instance, autonomous vehicles may have the potential to transform urban living by offering opportunity for safe, efficient, accessible, and affordable transportation.

As depicted in FIG. 1, the autonomous vehicle 10 may generally include a chassis 12, a body 14, front wheels 16, and rear wheels 18. The body 14 may be arranged on the chassis 12 and encloses components of the autonomous vehicle 10. The body 14 and the chassis 12 may jointly form a frame. The front wheels 16 and rear wheels 18 may be rotationally coupled to the chassis 12 near a respective corner of the body 14. In some examples, the chassis 12 may differ from the chassis on which the sensor arrays are mounted. For example, the sensor arrays can be mounted on the roof of the autonomous vehicle 10.

In various embodiments, the autonomous vehicle 10 may be an autonomous vehicle and the system 100 and/or components thereof may be incorporated into the autonomous vehicle 10. The autonomous vehicle 10 may be, for example, a vehicle that may be automatically controlled to carry passengers and/or cargo from one location to another. While the autonomous vehicle 10 may be depicted as a passenger car in FIG. 1, any other vehicle, including motorcycles, trucks, sport utility vehicles (SUVs), recreational vehicles (RVs), marine vessels, aircraft, and the like, can also be used as an autonomous vehicle.

In an example, the autonomous vehicle 10 may correspond to a level four or level five automation system under the Society of Automotive Engineers (SAE) “J3016” standard taxonomy of automated driving levels. Using this terminology, a level four system may indicate “high automation,” referring to a driving mode in which the automated driving system performs aspects of the dynamic driving task, even if a human driver does not respond appropriately to a request to intervene. A level five system may indicate “full automation,” referring to a driving mode in which the automated driving system performs aspects of the dynamic driving task under roadway and environmental conditions that can be managed by a human driver.

Implementations in accordance with the present subject matter are not limited to any taxonomy or rubric of automation categories. Furthermore, systems in accordance with the present disclosure can be used in conjunction with any autonomous, semi-autonomous, or manually operated vehicle.

As shown, the autonomous vehicle 10 may generally include a propulsion system 20, a transmission system 22, a steering system 24, a brake system 26, a sensor system 28, an actuator system 30, data storage device 32, controller 34, and a communication system 36. The propulsion system 20 can, in various embodiments, include an internal combustion engine, an electric machine such as a traction motor, and/or a fuel cell propulsion system. The transmission system 22 may be configured to transmit power from the propulsion system 20 to the front wheels 16 and rear wheels 18 according to selectable speed ratios. According to various implementations, the transmission system 22 can include a step-ratio automatic transmission, a continuously-variable transmission, or other appropriate transmission.

The brake system 26 may be configured to provide braking torque to the front wheels 16 and rear wheels 18. Brake system 26 can, in various embodiments, include friction brakes, brake by wire, a regenerative braking system such as an electric machine, and/or other appropriate braking systems.

The steering system 24 may influence a position of the front wheels 16 and/or rear wheels 18. While depicted as including a steering wheel 25 for illustrative purposes, in some embodiments contemplated within the scope of the present disclosure, the steering system 24 may not include a steering wheel.

The sensor system 28 may include one or more sensing devices 40a-40n that sense observable conditions of the exterior environment and/or the interior environment of the autonomous vehicle 10. The sensing devices 40a-40n can include radio detection and ranging (RADAR) sensors, light detection and ranging (LIDAR) sensors, global positioning systems (GPSs), optical cameras, thermal cameras, time-of-flight (TOF) cameras, ultrasonic sensors, speedometers, compasses, accelerometers, gyroscopes, and/or other sensors.

The actuator system 30 may include one or more actuator devices 42a-42n that control one or more vehicle features such as the propulsion system 20, the transmission system 22, the steering system 24, and the brake system 26. In various embodiments, the autonomous vehicle 10 can also include interior and/or exterior vehicle features not illustrated in FIG. 1, such as various doors, a trunk, and cabin features such as air conditioning, music players, lighting, touch-screen display components (such as those used in connection with navigation systems), and the like.

The data storage device 32 may store data for use in automatically controlling the autonomous vehicle 10. In various implementations, the data storage device 32 may store defined maps of the navigable environment. In various implementations, the defined maps may be predefined by and obtained from a remote system. For example, the defined maps may be assembled by the remote system and communicated to the autonomous vehicle 10 (wirelessly and/or in a wired manner) and stored in the data storage device 32. Route information can also be stored within the data storage device 32—i.e., a set of road segments (associated geographically with one or more of the defined maps) that together define a route that the user might take to travel from a start location (e.g., the user's current location) to a target location. In general, the data storage device 32 may include any suitable volatile or non-volatile memory technology, including double data rate (DDR) random access memory (RAM), synchronous RAM (SRAM), dynamic RAM (DRAM), flash, read-only memory (ROM), optical media, virtual memory regions, magnetic or tape memory, or any other suitable technology. Unless specified otherwise, any data storage devices or memory elements discussed herein should be construed as being encompassed within the broad term “memory.” As will be appreciated, the data storage device 32 can be part of the controller 34, separate from the controller 34, or part of the controller 34 and part of a separate system.

The controller 34 may include a processor 44 and a computer-readable storage device or media 46. The processor 44 can be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing computer instructions. The computer-readable storage device or media 46 can include volatile and non-volatile storage in ROM, RAM, and keep-alive memory (KAM), for example. KAM may be a persistent or non-volatile memory that can store various operating variables while the processor 44 is powered down. The computer-readable storage device or media 46 can be implemented using any of a number of memory devices such as PROMs (programmable read-only memory), EPROMs (electrically PROM), EEPROMs (electrically erasable PROM), flash memory, or any other electric, magnetic, optical, resistive, or combination memory devices capable of storing data, some of which represent executable instructions, used by the controller 34 in controlling the autonomous vehicle 10. As will be appreciated, while the computer-readable storage device or media 46 is depicted in FIG. 1 as part of the controller 34, the computer-readable storage device or media 46 can be part of the data storage device 32.

The instructions can include one or more separate programs that comprise an ordered listing of executable instructions for implementing logical functions. The instructions, when executed by the processor 44, can receive and process signals from the sensor system 28, perform logic, calculations, methods and/or algorithms for automatically controlling the components of the autonomous vehicle 10, and generate control signals transmitted to the actuator system 30 to control the components of the autonomous vehicle 10 based on the logic, calculations, methods, and/or algorithms. Although one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to control features of the autonomous vehicle 10.

In some embodiments, the controller 34 can perform various tasks using the deep learning model(s) 80 in accordance with the disclosure. The computer-readable storage device or media 46 can store instructions, that when executed by the processor 44, may perform various tasks and execute functions in accordance with the deep learning model(s) 80. For instance, the computer-readable storage device or media 46 may store deep learning model(s) 80 that are trained to, e.g., identify objects from sensor data captured by the sensor system 28. Furthermore, the computer-readable storage device or media 46 can store weights and other parameters of the deep learning model(s) 80. The deep learning model(s) 80 can perform one or more of the following tasks: perception, prediction, and control. The one or more deep learning model(s) 80 can generate outputs that can be used to control the operations of the autonomous vehicle 10. The deep learning model(s) 80 can include one or more of: environment-specific deep learning model(s) as described herein, and non-environment-specific deep learning model(s).

The communication system 36 may wirelessly communicates information to and from other entities 48, such as other vehicles (“V2V” communication), infrastructure (“V2I” communication), remote transportation systems, and/or user devices. In an example, the communication system 36 may be a wireless communication system configured to communicate via a wireless local area network (WLAN) using IEEE (Institute of Electrical and Electronics Engineers) 802.11 standards or by using cellular data communication (e.g., fifth-generation (5G) under the third Generation Partnership Project (3GPP)). Additional or alternate communication methods, such as a dedicated short-range communications (DSRC) channel, may also be considered within the scope of the present disclosure. DSRC channels may refer to one-way or two-way short-range to medium-range wireless communication channels specifically designed for automotive use and a corresponding set of protocols and standards.

In some cases, functionality of the physical hardware in autonomous vehicle 10 may be emulated by software (i.e., does not exist as a physical object, but exists virtually in non-transitory computer-readable signals and data). In other words, the functionality of the physical hardware in autonomous vehicle 10 may exist in the form of a simulated autonomous vehicle.

Exemplary Environments that are Different from Each Other

Environments can differ when the sets of vehicle hardware differ and/or the vehicle surroundings differ.

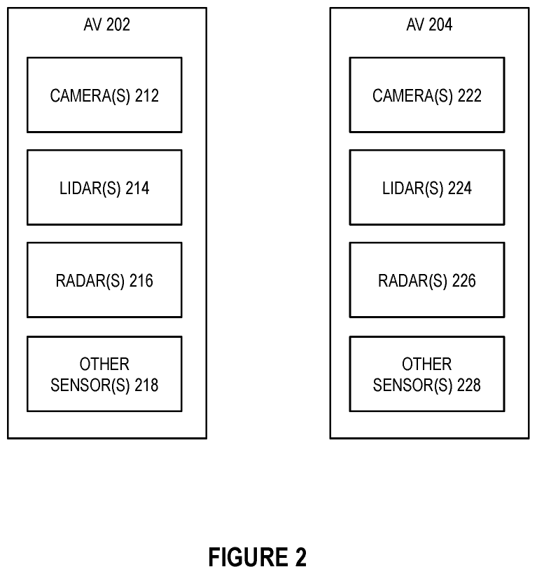

FIG. 2 illustrates autonomous vehicles with different sets of vehicle hardware, according to some embodiments of the disclosure. Autonomous vehicle 202 and autonomous vehicle 204 can be similar to autonomous vehicle 10 in FIG. 1. In this illustration, autonomous vehicle 202 has a first set of vehicle hardware, and autonomous vehicle 204 has a second set of vehicle hardware which is different from the first set of vehicle hardware. The first set of vehicle hardware may include one or more of types of hardware: camera(s) 212, LIDAR(s) 214, RADAR(s) 216, and other sensor(s) 208. The second set of vehicle hardware may include one or more of the following types of hardware: camera(s) 222, LIDAR(s) 224, RADAR(s) 226, and other sensor(s) 228.

Factors that make sets of vehicle hardware differ and cause different signals to be captured by the different hardware, can include one or more of the following:
The number of a given type of hardware, e.g., number of sensors,
The signal response of a given type of hardware can differ, e.g., camera detecting visible light versus a camera detecting infrared light,
The signal resolution of a given type of hardware can differ, e.g., a 10 megapixel camera versus a 50 megapixel camera,
The hardware settings and/or specifications of a given type of hardware, e.g., resolution, noise level, fidelity, range/distance, field of view, etc.,
The brand and/or model of a given type of hardware, and
The location in which the given type of hardware is positioned/installed on the autonomous vehicle.

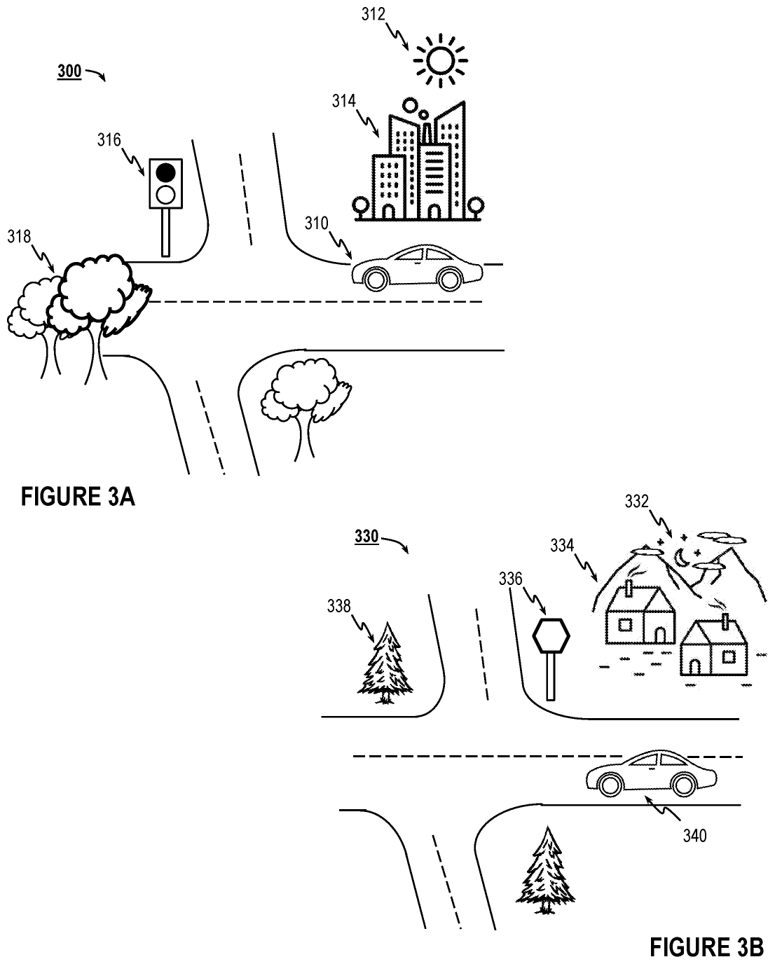

FIGS. 3A-3B illustrate ways how vehicle surroundings can differ, according to some embodiments of the disclosure. FIG. 3A illustrates a first vehicle surroundings 300 for autonomous vehicle 310. Autonomous vehicle 312 may be in a city setting with many high rise buildings on a flat topography (314) with sunny and clear skies 312 at high noon (312). The first vehicle surroundings 300 may utilize predominately traffic lights (316). The first vehicle surroundings 300 may have streets lined with oak trees (318). FIG. 3B illustrates a second vehicle surroundings 330 for autonomous vehicle 340 that is different from the first vehicle surroundings 300. Autonomous vehicle 340 may be in a rural setting with sparse houses on a rugged topography (314) with hazy skies 312 at night (312). The second vehicle surroundings 330 may utilize predominately stop signs (316). The second vehicle surroundings 330 may have streets lined with pine trees (338).

The exemplary ways how the first vehicle surroundings 300 and the second vehicle surroundings 330 can differ from each other, can include one or more of the following:
Locale/place (at varying levels of granularity, e.g., neighborhood, district city, county, state, region, country),
Legal jurisdictions,
   e.g., autonomous vehicle 310 drives on the right side of the road, and autonomous vehicle 340 drives on the left side of the road, and
   e.g., rules of the road,
Weather and atmospheric conditions (312 versus 332),
Lighting conditions (312 versus 332),
Actors on the road (e.g., people population type, density of cyclists, types of vehicles, etc.),
Time of day (312 versus 332),
Time of year or season (312 versus 332),
Rural, suburban, urban (314 versus 334),
Structures near a road (314 versus 334),
Topography (314 versus 334),
Road type (e.g., freeway, highway, residential streets, etc.),
Road signs and/or traffic signs (316 versus 336), and
Foliage and other types of objects near a road (318 versus 338).

Exemplary Environment-Specific Deep Learning Models

Environment-specific deep learning models can be constructed from agnostic nodes and dependent nodes. Dividing a deep learning model, i.e., carefully selecting and placing the agnostic nodes and dependent nodes is not trivial. In the following description, two different types of deep learning models, artificial neural networks and convolutional neural networks, are adapted to create environment-specific deep learning models. Other types of deep learning models adapted in the spirit of the invention are also envisioned as part of the disclosure. Exemplary considerations for how to divide a deep learning model into agnostic nodes and dependent nodes are also discussed in detail.

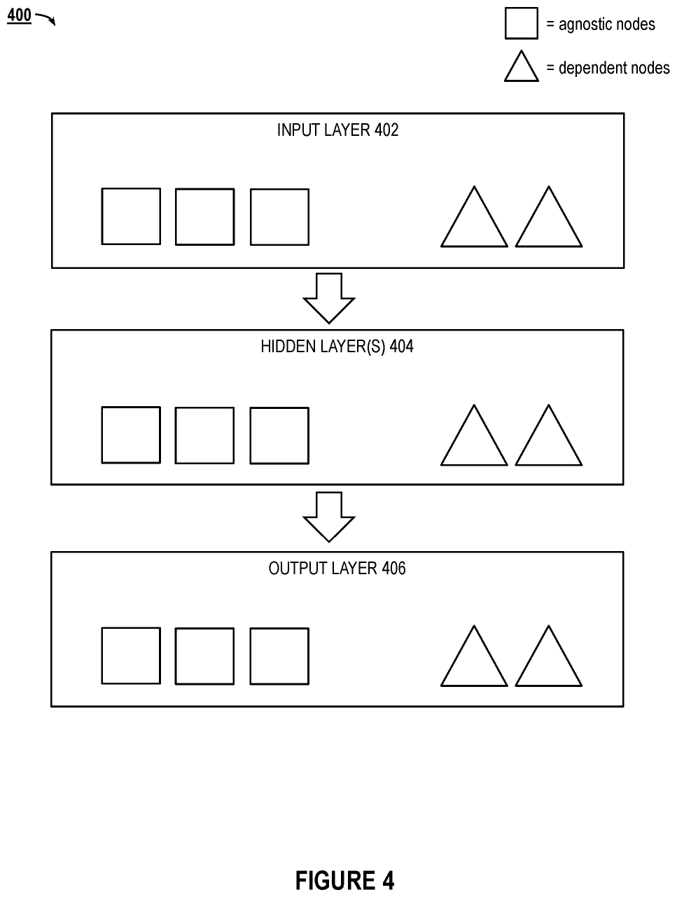

FIG. 4 illustrates an exemplary artificial neural network 400 having agnostic nodes and dependent nodes, according to some embodiments of the disclosure. The artificial neural network 400 has nodes (referred to in literature as artificial neurons) which are interconnected to each other in a network. A node can have one or more inputs and produces an output. The input can come from input data to the artificial neural network 400, or the input can come from the output of another node. The output can be sent to other nodes or can be an output of the artificial neural network. A node takes a weighted sum of all inputs (e.g., weighted by the input edges to the node). A bias can be added to this weighted sum to form the activation. The weights and the bias are considered the parameters of a node. The activation is then passed through an activation function of the node to produce the output of the node. The nodes of the artificial neural network 400 is typically organized in layers. Nodes of one layer connect only to nodes of the immediately preceding layer (if any) and the immediately following layer (if any). Between layers, nodes can be fully connected where each node is connected to every node in the next layer. Nodes can be pooled where a group of nodes are connected to just one node in the next layer. Some nodes can be connected to node(s) in the same layer or a previous layer. The artificial neural network 400 has nodes which are organized to have an input layer 402, one or more hidden layer(s) 404, and output layer 406. Each one of the layers shown can, in some cases, include one or more layers. Each one of the layers shown can have one or more nodes.

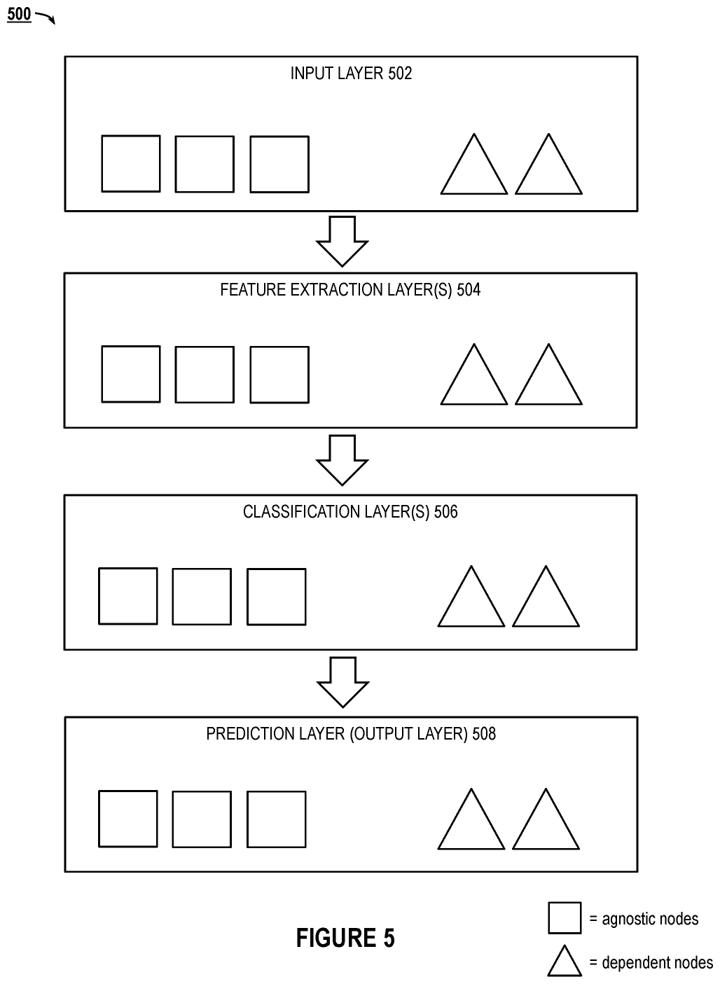

FIG. 5 illustrates an exemplary convolutional neural network 500 having agnostic nodes and dependent nodes, according to some embodiments of the disclosure. The convolutional neural network 500 is similar to the artificial neural network 400, but differs from the artificial neural network 400 in that the convolutional neural network 500 comprises kernels/filters in addition to nodes. The kernels/filters enables processing of a 2-dimensional activation maps, which may be more beneficial for processing input data that has spatial information. For simplicity, a kernel/filter is considered a node in this disclosure. The convolutional neural network 500 has nodes which are organized to have an input layer 502, feature extraction layer(s) 504, classification layer(s) 506, and a prediction layer (output layer) 508. The feature extraction layer(s) 504 can have nodes which are responsible for feature extraction. The classification layer(s) 506 can have nodes which are responsible for classification. The prediction layer 508 can have nodes responsible for prediction. Each one of the layers shown can, in some cases, include one or more layers. Each one of the layers shown can have one or more nodes.

Like other deep learning models, the artificial neural network 400 and the convolutional neural network 500 may have one or more hyperparameters, which can be may be set or learned. Hyperparameters may include learning rate, number of hidden layer(s) 404, and batch size.

Before constructing an environment-specific deep learning model for a new environment, a starting deep learning model is created and trained. The dataset used to train the starting deep learning model can be associated with a starting environment (which can include a set of starting environments). If there are multiple starting deep learning models corresponding to different starting environments, the starting deep learning model corresponding to a starting environment that is most similar to the new environment is selected and used.

To construct the environment-specific deep learning model for the new environment, the starting deep learning model is augmented or adapted to have agnostic nodes and dependent nodes. The starting deep learning model is augmented or adapted by selecting some nodes to become dependent nodes, adding nodes as dependent nodes, or a combination of both.

Some nodes of the starting deep learning model may be selected to become dependent nodes. In some instances, the parameters of the selected dependent nodes (or a subset of the parameters) may be initialized with the trained values (or a derivation thereof) of the starting deep learning model. In some instances, if some dependent nodes have been trained using a dataset having data collected in an environment that is similar to the new environment, the parameters of the selected dependent nodes may be initialized based on the trained values (or a derivation thereof) of those dependent nodes which have been trained using the dataset having data collected in the environment that is similar to the new environment. To identify the similar environment from a collection of different environments (and the dependent nodes trained with a dataset from that similar environment), characteristics/metrics of different environments can be compared and pairwise similarity scores may be computed based on the characteristics/metrics. The parameters of the selected dependent nodes (or a parameters of the weights) may be initialized with random values.

Some nodes may be added to the starting deep learning model to serve dependent nodes. The parameters of the newly added nodes (or a subset of the weights) may be initialized with random values. In some cases, if some dependent nodes have been trained using a dataset having data collected in an environment that is similar to the new environment, The parameters of the newly added nodes (or a subset of the parameters) may be initialized based on the trained values (or a derivation thereof) of those dependent nodes which have been trained using the dataset having data collected in the environment that is similar to the new environment, in the manner described in the previous paragraph.

Referring back to FIGS. 4, and 5, for a given layer, a positive number of nodes (including 0) can be provisioned as agnostic nodes, and a positive number of nodes (including 0) can be provisioned as dependent nodes for a specific environment. One or more layers can include a number of dependent nodes for a specific environment. In some cases, a whole layer of nodes may be provisioned as dependent nodes.

Provisioning dependent nodes for the new environment is not a trivial task. One or more considerations can be taken into account when provisioning one or more dependent nodes to create the environment-specific deep learning model.

In some instances, the number of dependent nodes (relative to the number of agnostic nodes) may depend on the relative sizes of a new dataset collected in the new environment and the dataset used to train the starting deep learning model. If the new dataset is significantly smaller than the dataset used to train the starting deep learning model, then a small number of nodes may be provisioned as dependent nodes to ensure the environment-specific deep learning model does not over fit to the limited new dataset, and/or to ensure more learnings from the starting deep learning model are maintained in the environment-specific deep learning model.

In some instances, the number of dependent nodes (relative to the number of agnostic nodes) may depend on the relative complexities of the new dataset collected in the new environment and the dataset used to train the starting deep learning model, or the relative complexities of the new environment and the starting environment. If the new dataset is significantly more complex than the dataset used to train the starting deep learning model, then a large number of nodes may be provisioned as dependent nodes to learn the complexities of the new dataset adequately.

In some instances, the number of dependent nodes (relative to the number of agnostic nodes) may depend on the extent in which the new dataset collected in the new environment and the dataset used to train the starting deep learning model differ from each other, or the extent in which the new environment and the starting environment differ from each other. If the new dataset is very different from the dataset used to train the starting deep learning model, then a small number of nodes may be provisioned as dependent nodes to avoid overfitting to the new dataset.

In some instances, location of the dependent nodes (i.e., which layer and its depth) is chosen based on the ways in which the new dataset collected in the new environment and the dataset used to train the starting deep learning model differ from each other, or the ways in which the new environment and the starting environment different from each other.

If the ways the new environment and the starting environment differ impact feature extraction, the dependent nodes (or more of them) may be provisioned in the input layer 502 and/or feature extraction layer(s). One example is that new environment may have different lighting conditions as the starting environment. Features of the environment may need to be extracted differently with different types of kernels/filters. One example is that new environment and the starting environment have different sets of vehicle hardware. Features of the environment may need to be extracted differently since the raw signals from the vehicle hardware may be very different.

If the ways the new environment and the starting environment differ impact classification, the dependent nodes (or more of them) may be provisioned in the classification layer(s). One example is that the new environment may have different traffic signs as the starting environment. Objects of the environment may need to be classified differently since there are new classes of objects to detect.

If the ways the new environment and the starting environment differ impact prediction, the dependent nodes (or more of them) may be provisioned in the prediction layer(s). One example is that the new environment and the starting environment may have different rules of the road. Prediction may need to be performed differently since vehicles on the road may operate differently (e.g., different set of allowed maneuvers). One example is that new environment and the starting environment have different sets of vehicle hardware (e.g., the distance or range of the LIDAR and RADAR sensors are different). Prediction may need to be performed since the allowed speed of the autonomous vehicle may differ.

Exemplary Methods for Training an Environment-Specific Deep Learning Model

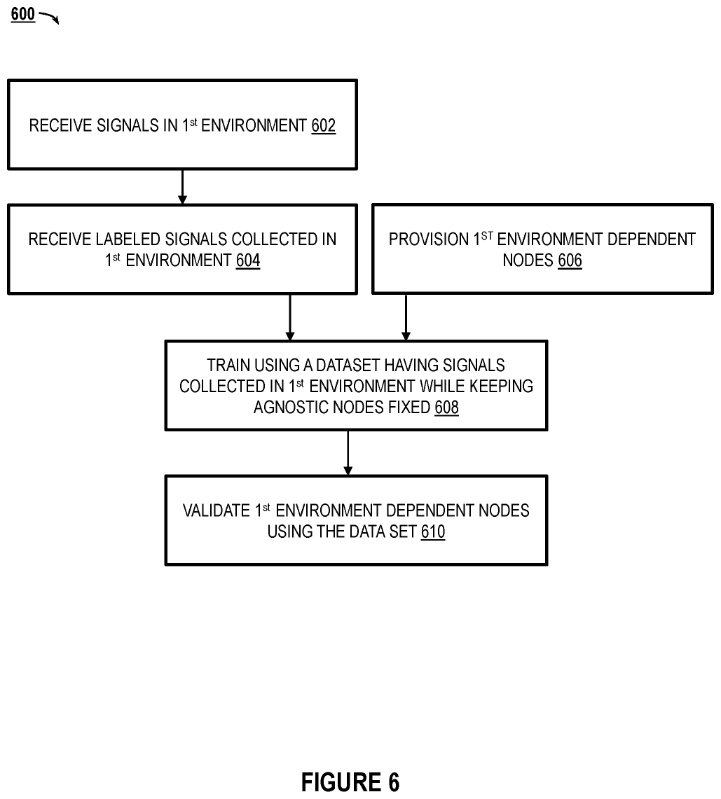

FIG. 6 is a flow diagram illustrating a method 600 for training a deep learning model, according to some embodiments of the disclosure. There may be many different environments. The method 600 to construct and train an environment-specific deep learning model can be applied when a dataset, having signals/data collected in a new environment that is different from the environments for which other deep learning models are trained, is available. The method 600 can be performed in a same or similar fashion when other datasets for other environments become available. Method 600 can be performed by computing systems in the infrastructure that supports a fleet of autonomous vehicles that rely on deep learning models to operate. In some cases, method 600 can be performed by computing systems provided in the fleet of autonomous vehicles.

In 602, signals collected in a first environment (e.g., the new environment) are received. The signals can be collected using vehicles operating in the first environment (e.g., with a specific set of vehicle hardware, and/or in a specific vehicle surroundings). The signals can be collected from simulation by simulated vehicles. For instance, the signals can be generated by a simulation system that can create a simulated vehicle surroundings and/or a simulated vehicle that emulates the first environment. The simulation system can augment scenes and/or objects from a different environment to create the simulated vehicle surroundings that resemble the first environment. The simulation system can artificially construct generate scenes and/or objects that resemble the first environment. The signals may include signals captured by sensors of a vehicle or a simulated vehicle, and/or information derived from the signals.

In 604, labeled signals collected in the first environment (forming a dataset) are received. Labeling creates a dataset that can be used for training a deep learning model. Labeling can be performed manually by human labelers, and/or assisted/performed by a computerized auto-labeling method. The labeled signals can be divided into a training dataset and a validation dataset. Data may be randomly selected to be in the training dataset or the validation dataset. The training dataset is used to train parameters of the deep learning model. The validation dataset is used to test the performance of the trained deep learning model.

In 606, one or more dependent nodes for the first environment are provisioned in an environment-specific deep learning model that is targeted for the first environment. The environment-specific deep learning model has agnostic nodes and dependent nodes provisioned in 606. Provisioning of dependent nodes can be performed using the various techniques described with FIGS. 4-5.

In 608, using the dataset from 604 (e.g., the training dataset portion), the environment-specific deep learning model is trained, updating the dependent nodes while keeping the agnostic nodes fixed. The updating of the nodes may comprise applying stochastic gradient updates on the weights and biases of the nodes based on backpropagation. The fixing of the nodes may comprise applying no update on, or maintaining the weights and biases of the nodes. To train a deep learning model, the training dataset is fed as input to the environment-specific deep learning model. Labeled data in the training dataset enables the parameters of environment-specific deep learning model to be optimized to minimize the error between model's output and the actual label of the input data. The optimization may perform backpropagation using a specific learning rate to update the parameters of the nodes in a deep learning model. Over many cycles, the parameters of the nodes converge to yield a deep learning model that is optimized to process the training dataset accurately. In 608, the parameters of the agnostic nodes are not updated or optimized. However, the parameters of the dependent nodes are updated and optimized using the training dataset.

In 610, the environment-specific deep learning model is validated using the dataset from 604 (e.g., the validation dataset portion) corresponding to the first environment, to evaluate the performance of the environment-specific deep learning model operating in the first environment. The validation dataset is fed to as input to the environment-specific deep learning model, and the outputs of the environment-specific deep learning model are evaluated against the labeled data to assess accuracy of the predictions generated by the environment-specific deep learning model operating in the first environment. Other types of cross-validation and evaluation techniques of the environment-specific deep learning model using the dataset from 604 are envisioned by the disclosure. If the validation results are satisfactory, the environment-specific deep learning model can be deployed in the first environment.

Optionally, the validation results can be used as feedback to 606 to modify the provisioning of the dependent nodes if the validation results are unsatisfactory.

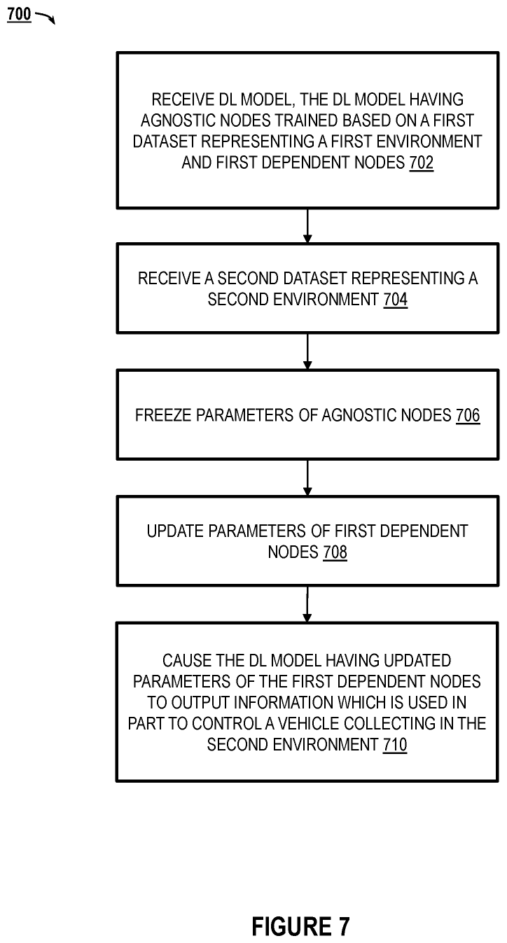

FIG. 7 is a flow diagram illustrating another method 700 for training a deep learning model, according to some embodiments of the disclosure. There may be many different environments. The method 700 to construct and train an environment-specific deep learning model can be applied when a dataset, having signals/data collected in a new environment that is different from the environments for which other deep learning models are trained, is available. The method 700 can be performed in a same or similar fashion when other datasets for other environments become available. Method 700 can be performed by computing systems in the infrastructure that supports a fleet of autonomous vehicles that rely on deep learning models to operate. In some cases, method 700 can be performed by computing systems provided in the fleet of autonomous vehicles.

In 702, a deep learning model is received. This deep learning model serves as the basis for an environment-specific deep learning model. The deep learning model can have agnostic nodes and dependent nodes. The agnostic nodes may be trained based on a first dataset representing a first environment (e.g., nodes from a starting deep learning model optimized for a starting environment). The dependent nodes are not yet trained/optimized. Provisioning of dependent nodes can be performed using the various techniques described with FIGS. 4-5.

In 704, a second dataset is received. The second dataset represents a second environment (e.g., a new environment) different from the first environment. The second dataset may be generated in accordance with 602 and 604 in FIG. 6.

In 706, parameters (e.g., weights) of the agnostic nodes in the deep learning model are frozen. In 708, parameters (e.g., weights) of the dependent nodes in the deep learning model are updated/optimized/trained. Freezing and updating of 706 and 708 may be performed in accordance with 608 in FIG. 6. Optionally, the deep learning model is validated in accordance with 610 in FIG. 6.

In 710, the deep learning model having updated parameters of the dependent nodes is caused (e.g., deployed) to output information which is used in part to control a vehicle in the second environment.

In some cases, the first dataset representing the first environment has signals collected using a first set of vehicle hardware, the second dataset representing the second environment has signals collected using a second set of vehicle hardware different from the first set of vehicle hardware, and the vehicle has the second set of vehicle hardware. Different sets of vehicle hardware are illustrated in FIG. 2.

In some cases, the first dataset representing the first environment has signals collected in a first vehicle surroundings, the second dataset representing the second environment has signals collected in a second vehicle surroundings different from the first vehicle surroundings; and the vehicle is operating in the second vehicle surroundings. Different vehicle surroundings are illustrated in FIGS. 3A-3B.

Exemplary Methods for Joint Optimization

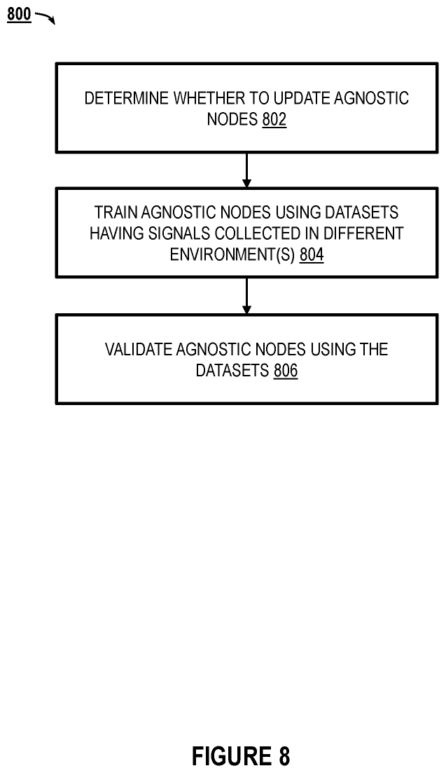

FIG. 8 is a flow diagram illustrating another method for training a deep learning model, according to some embodiments of the disclosure. Methods 600 and 700 can be used to create and deploy multiple environment-specific deep learning models optimized for different environments. In those methods, the parameters of the agnostic nodes of the deep learning models have been fixed or frozen. On occasion, the parameters of the agnostic nodes of across the multiple environment-specific deep learning models can be updated through joint optimization.

In 802, whether to update agnostic nodes is determined. The determination can be based on one or more factors. In some instances, the determination can be based on the amount of time passed since the last time the agnostic nodes are trained/updated. If the amount of time passed exceeds a threshold, then it is determined that the agnostic nodes are to be updated/trained. In some instances, the determination can be based on the amount of data collected for new environments since the last time the agnostic nodes are trained/updated. If the amount of data exceeds a threshold (e.g., defined based on the relative size of the data collected for new environments and the dataset used in training the agnostic nodes), then it is determined that the agnostic nodes are to be updated/trained. In some instances, the determination can be based on the cost of training the agnostic nodes. Training the agnostic nodes may only be performed if budget allows or budget is allocated.

In 804, agnostic nodes are trained using datasets having signals collected in the different environments. In other words, the datasets corresponding to different environments (e.g., a training dataset portion) are fed as input to a deep learning model having the agnostic nodes, and the parameters of the agnostic nodes are updated to minimize the error of the deep learning model. Extending the method 700 in FIG. 7, parameters of the agnostic nodes can be updated using the first dataset and the second dataset, and the deep learning model having updated parameters of the agnostic nodes can be caused to output information which is used in part to control a further vehicle.

In 806, the agnostic nodes can be validated using the datasets having signals collected in different environments. For instance, a deep learning model having the updated agnostic nodes can be evaluated by feeding the datasets corresponding to different environments (e.g., a validation dataset portion) as input, and evaluating the performance of the deep learning model operating in the different environments.

The updated parameters of the agnostic nodes (which are jointly optimized using datasets corresponding to different environments) can be distributed/deployed to the agnostic nodes of the various different environment-specific deep learning models (models created via methods 600 and 700). The environment-specific deep learning modes can benefit from the learnings of joint optimization.

Exemplary Methods for Applying an Environment-Specific Deep Learning Model

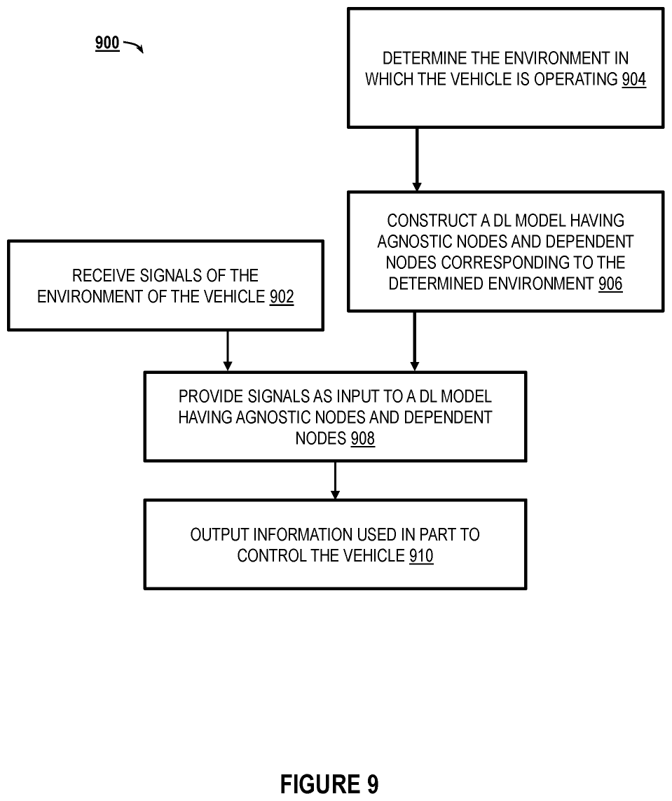

FIG. 9 is a flow diagram illustrating a method 900 for applying a deep learning model, according to some embodiments of the disclosure. The method 900, can be used for perceiving an environment of a vehicle and controlling the vehicle. In operation, in the real world or in simulation, the vehicle can apply an environment-specific deep learning model and control the vehicle based on outputs of the environment-specific deep learning model. The (environment-specific) deep learning model being applied in method 900 has agnostic nodes whose parameters are trained based on a first dataset (e.g., corresponding to a starting environment). In response to determining that the vehicle is in a second environment, the deep learning model being applied in method 900 can be provisioned with dependent nodes whose parameters are trained based on a second dataset (e.g., corresponding to a new environment), the second dataset being different from the first dataset. Method 900 can be performed by computing systems (e.g., simulation systems) in the infrastructure that supports a fleet of vehicles that rely on deep learning models to operate. In some cases, method 900 can be performed by computing systems provided in the fleet of vehicles.

In some instances, the first dataset is associated with a first environment. The second dataset is associated with a second environment different from the first environment. The vehicle is in the second environment. Different environments are illustrated in FIGS. 2 and 3A-3B.

In some instances, the first dataset is associated with a first set of vehicle hardware. The second dataset is associated with a second set of vehicle hardware different from the first set of hardware. The vehicle has the second set of vehicle hardware. Different sets of vehicle hardware are illustrated in FIG. 2.

In some instances, the first dataset is associated with a first vehicle surroundings. The second dataset is associated with a second vehicle surroundings different from the first vehicle surroundings. The vehicle is operating in the second vehicle surroundings. Different vehicle surroundings are illustrated in FIGS. 3A-3B.

In 902, signals of the environment of the vehicle collected by sensors of the vehicle are received. The signals can be the same or similar to the signals referenced in 602 of FIG. 6.

In 904, the vehicle is determined to be operating in a second environment. An environment can be defined based on a set of characteristics. The characteristics of the second environment can be checked using different modalities and information to assess if the vehicle is operating in the second environment. In some cases, the second environment is determined based on information extracted from the signals in 902. In some cases, the second environment is determined based on localization information of the vehicle. Localization information can be based on one or more of: GPS information, camera information, RADAR information, LIDAR information, map information, weather information, time information, date information, etc. In some cases, the second environment is determined based on the set of vehicle hardware provided in the vehicle. In some cases, a data store having a list of vehicle hardware identification information can be query to confirm whether the vehicle is operating in a second environment.

In 906, in response to the determination in 904, the deep learning model having the agnostic nodes and the dependent nodes can be constructed. The dependent nodes correspond to the second environment. Ways in which the dependent nodes can be provisioned are detailed in relation to FIGS. 4-5.

In 908, the signals in 902 are provided as input to the deep learning model in 906. The agnostic nodes and dependent nodes of the deep learning model can process the signals to perform tasks such as feature extraction, classification, and prediction.

In 910, the deep learning model outputs information which is used in part to control the vehicle.

If the vehicle is determined to be operating in a third environment that is not the second environment, a different deep learning model can be constructed based on the agnostic nodes and further dependent nodes that corresponds to the third environment. Advantageously, the vehicle can adapt to different environments by constructing and applying different environment-specific deep learning models.

In some cases, the second environment has a combination of different environments. The combination can be weighted or non-weighted. In some cases, the second environment has a mixture of characteristics from a set of different environments. In 906, the deep learning model being constructed may include agnostic nodes, and dependent nodes that separately correspond to each environment in the different environments. For instance, the deep learning model may include agnostic nodes, first dependent nodes corresponding to a first environment in the different environments, and second dependent nodes corresponding to a second environment in the different environments.

Exemplary Computing Systems

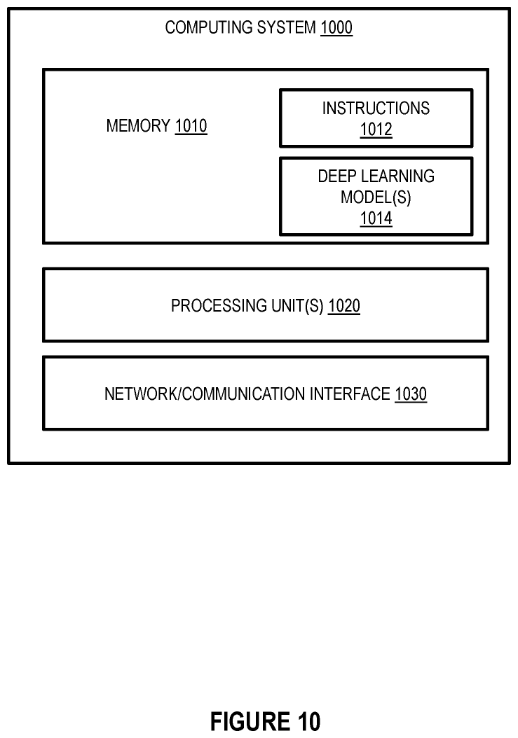

FIG. 10 illustrates an exemplary computing system 1000 used in various embodiments of the disclosure. The computing system 1000 can be present in an autonomous vehicle (e.g., the autonomous vehicle 10). In some embodiments, the computing system 100 can be present in infrastructure for training deep learning models to be used in autonomous vehicle. In some embodiments, the computing system 100 can be present in infrastructure for simulating vehicles and the deep learning models being used in the simulated vehicles.

Referring to FIG. 10, system 1000 can be implemented within one computing device or distributed across multiple computing devices or sub-systems that cooperate in executing program instructions. In some implementations, the system 1000 can include one or more blade server devices, standalone server devices, personal computers, routers, hubs, switches, bridges, firewall devices, intrusion detection devices, mainframe computers, network-attached storage devices, smartphones and other mobile telephones, and other computing devices. The system hardware can be configured according to any suitable computer architectures such as a Symmetric Multi-Processing (SMP) architecture or a Non-Uniform Memory Access (NUMA) architecture.

The system 1000 can include one or more processing units 1020, which can include one or more hardware processors and/or other circuitry that retrieves and executes instructions 1012 (e.g., software or firmware codes) from memory 1010. The one or more processing units 1020 can be implemented within one processing device, chip, or package, and can also be distributed across multiple processing devices, chips, packages, or sub-systems that cooperate in executing program instructions. In one implementation, the one or more processing units 1020 may include a CPU and a GPU. The GPU can execute the visual/image processing in the computing system. The GPU, or any second-order processing element independent from CPU dedicated to processing imagery and other perception data in real or near real-time, can provide a significant benefit.

The memory 1010 can include any computer-readable storage media readable by one or more processing unit(s) 1020 and that stores instructions 1012 for executing any one or more of the methods described and illustrated herein, and one or more deep learning models 1014 as described and illustrated herein (e.g., its weights, and other parameters). The memory 1010 can be implemented as one storage device and can also be implemented across multiple co-located or distributed storage devices or sub-systems. The memory 1010 can include additional elements, such as a controller, that communicate with the one or more processing units 1020. The memory 1010 can also include storage devices and/or sub-systems on which data and/or instructions may be stored. System 1000 can access one or more storage resources to access information to carry out any of the processes indicated by instructions 1012.

The instructions 1012, including routines for at least partially performing at least one of the processes illustrated in the FIGURES, can be implemented in program instructions. Further, the instructions 1012, when executed by system 1000 in general or the one or more processing unit(s) 1020 in particular, can direct, among other functions, the system 1000 or the one or more processing units 1020 to operate as described herein.

In implementations where the system 1000 includes multiple computing devices, the server can use one or more communications networks that facilitate communication among the computing devices. For example, the one or more communications networks can include or be a local or wide area network that facilitates communication among the computing devices. One or more direct communication links can be included between the computing devices. In addition, the computing devices can be installed at geographically distributed locations or at one geographic location, such as a server farm or an office.

System 1000 can include a communications interface 1030 that provides one or more communication connections and/or one or more devices that allow for communication between system 1000 and other computing systems (not shown) over a communication network or collection of networks (not shown) or the air.

### SELECTED EXAMPLES

Example 1 is a method for perceiving an environment of a vehicle and controlling the vehicle, the method comprising: receiving, signals of the environment of the vehicle collected by sensors of the vehicle; providing the signals as input to a deep learning model; wherein the deep learning model comprises: agnostic nodes whose parameters are trained based on a first dataset; and dependent nodes whose parameters are trained based on a second dataset, the second dataset being different from the first dataset; outputting, by the deep learning model, information which is used in part to control the vehicle.

In Example 2, the method of Example 1, can optionally include: the first dataset being associated with a first environment; the second dataset being associated with a second environment different from the first environment; and the vehicle being in the second environment.

In Example 3, the method of Example 1 or 2 can optionally include: the first dataset being associated with a first set of vehicle hardware; the second dataset being associated with a second set of vehicle hardware different from the first set of hardware; and the vehicle having the second set of vehicle hardware.

In Example 4, the method of any one of Examples 1-3 can optionally include: the first dataset being associated with a first vehicle surroundings; the second dataset being associated with a second vehicle surroundings different from the first vehicle surroundings; and the vehicle operating in the second vehicle surroundings.

In Example 5, the method of any one of Examples 1-4 can optionally include the dependent nodes comprising nodes responsible for feature extraction.

In Example 6, the method of any one of Examples 1-5 can optionally include the dependent nodes comprising nodes responsible for classification.

In Example 7, the method of any one of Examples 1-6 can optionally include the dependent nodes comprising nodes responsible for prediction.

In Example 8, the method of any one of Examples 1-7 can optionally include the dependent nodes comprising two or more of the following types of nodes: nodes responsible for feature extraction, nodes responsible for classification, and nodes responsible for prediction.

In Example 9, the method of any one of Examples 1-8 can optionally include agnostic nodes being trained further based on the first dataset and the second dataset.

In Example 10, the method of any one of Examples 1-9 can optionally include the deep learning model having a larger proportion of agnostic nodes than dependent nodes.

In Example 11, the method of any one of Examples 1-10 can optionally include: the first dataset being associated with a first environment; the second dataset being associated with a second environment different from the first environment; and the method further comprising: determining that the vehicle is in a second environment; and construct the deep learning model having the agnostic nodes and the dependent nodes, in response to the determination.

Example 12 is a computing system for a vehicle, the vehicle having one or more sensors communicably coupled to the computing system, the one or more sensors to sense an environment of the vehicle, the computing system comprising: one or more processing units; and one or more non-transitory, computer-readable media having instructions and parameters of a deep learning model stored thereon; wherein the deep learning model comprises: agnostic nodes whose parameters are trained based on a first dataset; and dependent nodes whose parameters are trained based on a second dataset, the second dataset being different from the first dataset; and wherein the instructions when executed by the one or more processing units, causes the one or more processing units to perform the following: receive, signals of the environment of the vehicle collected by the one or more sensors; provide the signals as input to the deep learning model; and output, by the deep learning model, information which is used in part to control the vehicle.

In Example 13, the computing system of Example 12, can optionally include the instructions when executed by the one or more processing units, causing the one or more processing units to further perform any one of the methods of claims 2-11.

Example 101 is a method for sharing parameters between deep learning models, the method comprising: receiving a deep learning model, wherein the deep learning model has agnostic nodes and dependent nodes, and the agnostic nodes are trained based on a first dataset representing a first environment; receiving a second dataset, wherein the second dataset represents a second environment different from the first environment; freezing parameters of the agnostic nodes of the deep learning model; updating parameters of the dependent nodes using the second dataset; and causing the deep learning model having updated parameters of the dependent nodes to output information which is used in part to control a vehicle in the second environment.

In Example 102, the method of Example 101, wherein: the first dataset representing the first environment has signals collected using a first set of vehicle hardware; the second dataset representing the second environment has signals collected using a second set of vehicle hardware different from the first set of vehicle hardware; and the vehicle has the second set of vehicle hardware.

In Example 103, the method of Example 101 or 102 can optionally include: the first dataset representing the first environment having signals collected in a first vehicle surroundings; the second dataset representing the second environment having signals collected in a second vehicle surroundings different from the first vehicle surroundings; and the vehicle operating in the second vehicle surroundings.

In Example 104, the method of any one of Examples 101-103 can optionally include the dependent nodes comprising nodes in the deep learning model responsible for feature extraction.

In Example 105, the method of any one of Examples 101-104 can optionally include the dependent nodes comprising nodes in the deep learning model responsible for classification.

In Example 106, the method of any one of Examples 101-105 can optionally include the dependent nodes comprising nodes in the deep learning model responsible for prediction.

In Example 107, the method of any one of Examples 101-106 can optionally include the dependent nodes comprising two or more of the following types of nodes in the deep learning model: nodes responsible for feature extraction, nodes responsible for classification, and nodes responsible for prediction.

In Example 108, the method of any one of Examples 101-107 can optionally include updating parameters of the agnostic nodes using the first dataset and the second dataset; and causing the deep learning model having updated parameters of the agnostic nodes to output information which is used in part to control a further vehicle.

In Example 109, the method of any one of Examples 101-108 can optionally include the deep learning model having a larger proportion of agnostic nodes than dependent nodes.

Example 110 is one or more non-transitory, computer-readable media encoded with instructions that, when executed by one or more processing units, perform a method according to any one of Examples 1-11, and 101-109.

Example 111 is a computing system comprising: one or more processing units; one or more non-transitory, computer-readable media having instructions stored thereon and executable by the one or more processing units; wherein the instructions when executed by the one or more processing units, causes the one or more processing units to perform a method according to any one of Examples 1-11, and 101-109.

Example 112 includes an apparatus comprising means for performing the method of according to any one of Examples 1-11, and 101-109.

Variations and Implementations

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

The systems, methods and devices of this disclosure have several innovative aspects, no one of which is solely responsible for the attributes disclosed herein. Details of one or more implementations of the subject matter described in this specification are set forth in the description below and the accompanying drawings. The foregoing disclosure presents various descriptions of certain specific embodiments. The innovations described herein can be embodied in a multitude of different ways, for example, as defined and covered by the claims and/or Select Examples. In the following description, reference is made to the drawings where like reference numerals can indicate identical or functionally similar elements. Elements illustrated in the drawings are not necessarily drawn to scale. Additionally, certain embodiments can include more elements than illustrated in a drawing and/or a subset of the elements illustrated in a drawing. Further, some embodiments can incorporate any suitable combination of features from two or more drawings.

As will be appreciated by one skilled in the art, aspects of the present disclosure, in particular, methods enabling sharing of parameters across environment-specific deep learning models, described herein, can be embodied in various manners (e.g., as a method, a system, a computer program product, or a computer-readable storage medium). Accordingly, aspects of the present disclosure can take the form of a hardware implementation, a software implementation (including firmware, resident software, or micro-code) or an implementation combining software and hardware aspects that can generally be referred to herein as a “circuit,” “module” or “system.” Functions described in this disclosure can be implemented as an algorithm executed by one or more hardware processing units, e.g. one or more microprocessors of one or more computers. In various embodiments, different steps and portions of the operations of the methods described herein can be performed by different processing units. Furthermore, aspects of the present disclosure can take the form of a computer program product embodied in one or more computer-readable media having computer-readable program code embodied, e.g., stored or encoded, thereon. In various embodiments, such a computer program can, for example, be downloaded (or updated) to the existing devices and systems or be stored upon manufacturing of these devices and systems.

The ‘means for’ as used in the present disclosure and claims can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

In addition, the terms “storage media,” “computer-readable storage media,” or “computer-readable storage medium” can refer to non-transitory storage media, such as a hard drive, a memory chip, and cache memory.

Note that the functions related to various methods for training and applying deep learning models (e.g., described and illustrated with FIGS. 4-9), illustrate some of the possible functions that can be executed by, or within, the systems illustrated in the FIGS. 1 and 10. Some of these operations can be deleted or omitted where appropriate, or these operations can be modified or changed considerably. In addition, the timing of these operations can be altered considerably. The preceding operational flows have been offered for purposes of example and discussion. Implementations described herein provide flexibility, in that any suitable arrangements, chronologies, configurations, and timing mechanisms can be provided.

Numerous other changes, substitutions, variations, alterations, and modifications might be ascertained by one skilled in the art, and the present disclosure encompasses such changes, substitutions, variations, alterations, and modifications as falling within the scope of the appended claims. Optional features of the apparatus described above can be implemented with respect to the method or process described herein and specifics in the examples can be used anywhere in one or more embodiments.

What is claimed is:

1. A method for perceiving an environment of a vehicle and controlling the vehicle, the method comprising:
receiving, signals of the environment of the vehicle collected by sensors of the vehicle;
providing the signals as input to a deep learning model, wherein the deep learning model comprises: agnostic nodes whose parameters are trained based on a first dataset; and dependent nodes whose parameters are trained based on a second dataset, the second dataset being different from the first dataset; and
outputting, by the deep learning model, information which is used in part to control the vehicle.

2. The method of claim 1, wherein:
the first dataset is associated with a first environment;
the second dataset is associated with a second environment different from the first environment; and
the vehicle is in the second environment.

3. The method of claim 1, wherein:
the first dataset is associated with a first set of vehicle hardware;
the second dataset is associated with a second set of vehicle hardware different from the first set of hardware; and
the vehicle has the second set of vehicle hardware.

4. The method of claim 1, wherein:
the first dataset is associated with a first vehicle surroundings;
the second dataset is associated with a second vehicle surroundings different from the first vehicle surroundings; and
the vehicle is operating in the second vehicle surroundings.

5. The method of claim 1, wherein the dependent nodes comprises nodes responsible for feature extraction.

6. The method of claim 1, wherein the dependent nodes comprises nodes responsible for classification.

7. The method of claim 1, wherein the dependent nodes comprises nodes responsible for prediction.

8. The method of claim 1, wherein the dependent nodes comprises two or more of the following types of nodes: nodes responsible for feature extraction, nodes responsible for classification, and nodes responsible for prediction.

9. The method of claim 1, wherein agnostic nodes are trained further based on the first dataset and the second dataset.

10. The method of claim 1, wherein the deep learning model has a larger proportion of agnostic nodes than dependent nodes.

11. The method of claim 1, wherein:
the first dataset is associated with a first environment;
the second dataset is associated with a second environment different from the first environment; and
the method further comprises:
determining that the vehicle is in a second environment; and
construct the deep learning model having the agnostic nodes and the dependent nodes, in response to the determination.

12. A computing system for a vehicle, the vehicle having one or more sensors communicably coupled to the computing system, the one or more sensors to sense an environment of the vehicle, the computing system comprising:
one or more processing units; and
one or more non-transitory, computer-readable media having instructions and parameters of a deep learning model stored thereon;
wherein the deep learning model comprises: agnostic nodes whose parameters are trained based on a first dataset; and dependent nodes whose parameters are trained based on a second dataset, the second dataset being different from the first dataset; and
wherein the instructions when executed by the one or more processing units, causes the one or more processing units to perform the following:
receive, signals of the environment of the vehicle collected by the one or more sensors;
provide the signals as input to the deep learning model; and
output, by the deep learning model, information which is used in part to control the vehicle.

13. A method for sharing parameters between deep learning models, the method comprising:
receiving a deep learning model, wherein the deep learning model has agnostic nodes and dependent nodes, and the agnostic nodes are trained based on a first dataset representing a first environment;
receiving a second dataset, wherein the second dataset represents a second environment different from the first environment;
freezing parameters of the agnostic nodes of the deep learning model;
updating parameters of the dependent nodes using the second dataset; and
causing the deep learning model having updated parameters of the dependent nodes to output information which is used in part to control a vehicle in the second environment.

14. The method of claim 13, wherein:
the first dataset representing the first environment has signals collected using a first set of vehicle hardware;
the second dataset representing the second environment has signals collected using a second set of vehicle hardware different from the first set of vehicle hardware; and
the vehicle has the second set of vehicle hardware.

15. The method of claim 13, wherein:
the first dataset representing the first environment has signals collected in a first vehicle surroundings;
the second dataset representing the second environment has signals collected in a second vehicle surroundings different from the first vehicle surroundings; and
the vehicle is operating in the second vehicle surroundings.

16. The method of claim 13, wherein the dependent nodes comprises nodes in the deep learning model responsible for feature extraction.

17. The method of claim 13, wherein the dependent nodes comprises nodes in the deep learning model responsible for classification.

18. The method of claim 13, wherein the dependent nodes comprises nodes in the deep learning model responsible for prediction.

19. The method of claim 13, wherein the dependent nodes comprises two or more of the following types of nodes in the deep learning model: nodes responsible for feature extraction, nodes responsible for classification, and nodes responsible for prediction.

20. The method of claim 13, further comprising:
updating parameters of the agnostic nodes using the first dataset and the second dataset; and
causing the deep learning model having updated parameters of the agnostic nodes to output information which is used in part to control a further vehicle.
